(19) United States
(12) Patent Application Publication
(10) Pub. No.: US 2014/0038512 A1
(43) Pub. Date: Feb. 6, 2014

(54) MOVABLE BROADCASTING SYSTEM BY USING A CODE SET IDENTIFICATION

(71) Applicant: LIN- HAO YANG, Taipei Hsien (TW)

(72) Inventor: LIN- HAO YANG, Taipei Hsien (TW)

(21) Appl. No.: 13/565,787

(22) Filed: Aug. 2, 2012

(51) Int. Cl. H04W 4/06

(52) U.S. Cl. 455/3.01

(57) ABSTRACT

A movable broadcasting system by using a code set identification comprises a code transmitter installed at a predetermined location; the code transmitter storing at least one code set which can be transferred to at least one wireless application device within an area around the predetermined location by wireless communication; an application program installed in the wireless application device. When the wireless application device receives signals from the code transmitter, the application program in the wireless application device will drive the wireless application device to further transmit the code set. A server store all the code sets and a plurality of data corresponding to the code set. When the server receives the code set from the handset, it will find a data corresponding to the code set and then transfer the data back to the handset wirelessly.

### FIELD OF THE INVENTION

The present invention relates to data broadcasting for advertisement, and in particular to a movable broadcasting system by using a code set identification.

### BACKGROUND OF THE INVENTION

Conventionally, advertisements are broadcasted through advertisement plates, advertisement papers, or display screens in specific locations. Currently, networks are widely used. More and more advertisements are broadcasted through networks. Conventional practical advertisement medium is changed by a virtual advertisement medium due to the advantages of easy operation and easy change of the contents, quick playing, power and labor savings, etc.

Conventionally, many advertisements for local usages are performed by advertisement plates or display screens. However this way needs space for locating the plates or screen. Furthermore, the managements of the contents are complex and inconveniently.

Thus, there is an eager demand for a novel way which uses the currently network advertisement to replace the conventional local advertisement so as to provide a convenient, coat saving advertisements to users.

### SUMMARY OF THE INVENTION

Accordingly, the present invention provides a movable broadcasting system by using a code set identification, wherein the present invention provides a new way for broadcasting to specific customers based on specific locations. Nowadays tablet computers and handsets are widely used. By the present invention, the advertisements can be provided to specific customers in specific locations. Furthermore, the contents of the advertisements are transferred to the customers electronically and wirelessly. No space is needed for the advertisement provides in the specific location. Furthermore, by the present invention, the contents of the advertisement can be changed rapidly by changing the contents in the provider database through a computer connected to the servers. Thus the advertisement is effectively transferred and the space for displaying the advertisement is saved.

To achieve above object, the present invention provides a movable broadcasting system by using a code set identification which comprises a code transmitter installed at a predetermined location; the code transmitter storing at least one code set which can be transferred to at least one wireless application device within an area around the predetermined location by wireless communication; an application program installed in the wireless application device; when the wireless application device receives signals from the code transmitter, the application program in the wireless application device will drive the wireless application device to further transmit the code set; and a server storing all the code sets and a plurality of data corresponding to the code set; when the server receives the code set from the handset, it will find a data corresponding to the code set and then transfer the data back to the handset wirelessly.

Furthermore, in detail, the a server may comprises a provider database for storing data inputted by external providers; each data of the provider being directed to a code set; the code set being stored in the code transmitter; a customer interface connected to the provider database for interfacing with external customers through a wireless application device; the customer interface receiving the code set and then transfers the code set to the provider database; then a data corresponding to the code set is found in the provider database; then the data corresponding to the code set being transferred back to the wireless application device; and a code controller connected to the provider database; the code controller serving to manage the code sets between the code transmitter and the provider database.

### BRIEF DESCRIPTION OF THE DRAWINGS

FIG. 1 s a schematic view showing the first embodiment of the present invention

FIG. 2 is a schematic view showing the second embodiment of the present invention.

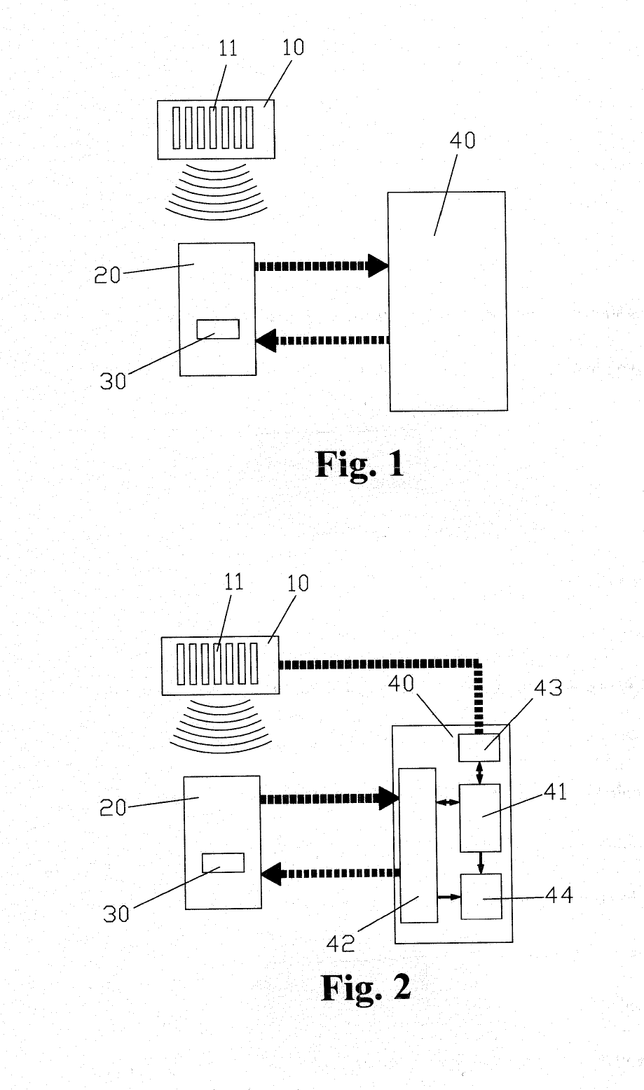

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to a movable broadcasting system by using a code set identification. The structure of the present invention will be described herein.

A code transmitter 10 is installed at a specific location. The code transmitter 10 has at least one code set 11 which can be transferred to at least one wireless application device 20 within an area around the specific location by wireless communication, such as WiFi, Bluetooth, NFC, etc. The wireless application device 20 is such as a handset, a flat computer, etc. In the following, a handset is used for description, however this is not used to confine the scope of the present invention.

The code set in the code transmitter 10 is adjustable and a plurality of code sets can be designated to the code transmitter 10. The code set 11 in the code transmitter 10 is adjusted by wireless way or wired way.

An application program 30 is installed in the handset. When the handset 20 receives signals from the code transmitter 10, the application program 30 in the handset will drive the handset 20 to further send out the code set to a specific receiver;

A server 10 stores all the code sets and a plurality of data corresponding to the code set. When the server 40 receives the code set from the handset, it will find the data corresponding to the code set and then transfer the data back to the handset 20 wirelessly. The application program 30 causes the handset 20 to display the data on the screen thereof.

An application of the present invention will be described herein. In this example, the code transmitter 10 is located in a coffee shop. The code transmitter 10 stores the specific code set 11 for the coffee shop. The code set 11 can be transfer to customer handsets wirelessly, wherein the handset has installed with the application program 30 of the present invention. Then the application program 30 drives the handset to transfer the code set 11 to a server 40 at far end. The server 40 will transfer the data about the code set 11 to the handset. The data is such as the prices of coffees sold in the coffee shop, or other advertise information. Thus the customer having the handset in the coffee shop can receive these data.

Another application about the present invention is that: the code transmitter 10 is located in a moving vehicle. The code transmitter 10 has a code set. The code transmitter 10 transmits the code set to the handsets around the vehicle with a specific range. After the handsets receive the code set, the code set will be further transferred to a far end server 40. The server 40 will transfer the data about the code set 11 to the handset. However with the movement of the vehicle, the data will transfer to a plurality of handsets at a range around the moving trace of the vehicle.

With reference to FIG. 2, a business model constructed by above mentioned structure of the present invention will be described herein. The system based on the model comprises the following elements.

A code transmitter 10 is installed at a specific location. The code transmitter 10 has at least one code set 11 which can be transferred to at least one wireless application device 20 within an area around the specific location by wireless communication, such as WiFi, Bluetooth, NFC, etc. The wireless application device 20 is such as a handset, a flat computer, etc. The wireless application device 20 has received an application program 30 which causes the code set to be transmitted out.

A server 40 server to perform the operation of the present invention.

The server 40 of the present invention includes the following elements.

A provider database 41 server to store data inputted by external providers. Each data of the provider is given a code set 11. Also the code set 11 is stored in the code transmitter 10. Each data can be set with conditions for transmission, such as to be transmitted only at afternoon or at night, or to be transmitted at sunny day or raining day.

A customer interface 42 is connected to the provider database 41 for interfacing with external customers through a wireless application device 20. The customer interface 42 receives the code set 11 and then transfers the code set 11 to the provider database 41. Then a data corresponding to the code set 11 is found in the provider database 41. Then the data corresponding to the code set 11 is transferred back to the wireless application device 20. The application program 30 in the wireless application device 20 will display the data on a screen thereof.

A code controller 43 is connected to the provider database 41. The code controller 43 server to manage the code sets 11 between the code transmitter 10 and the provider database 41. The code sets set by external providers can be transferred to the code transmitter 10 wirelessly or by wired connection.

A charge unit 44 is connected to the customer interface 42 and the provider database 41 for charging to the external providers or customers due to the operation from customers or the providers.

In using, when an external provider registered to the provider database 41 in the server 40 and inputs data to the provider, the data in the provider database 41 will be coded with the code set 11. The code set 11 is than transferred to the code transmitter 10 through the code controller 43. Thus the application as described in the first embodiment is actuated by the website of the present invention. Finally, the website owning the server 40 can charge to the providers or customers through the charge unit 44.

Advantage of the present invention is that the present invention provides a new way for broadcasting to specific customers based on the locations of the customers. Since currently, tablet computers and handsets are widely used, by the present invention, the advertisements can be secretly provided to specific customers in specific locations. Furthermore, the contents of the advertisements are transferred to the customers electronically and wirelessly. No space is needed for the advertisement provides in the specific location. Furthermore, by the present invention, the contents of the advertisement can be changed rapidly by changing the contents in the provider database through a computer connected to the servers. Thus the advertisement is effectively transferred and the space for displaying the advertisement is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A movable broadcasting system by using a code set identification, comprising:
a code transmitter installed at a predetermined location; the code transmitter storing at least one code set which can be transferred to at least one wireless application device within an area around the predetermined location by wireless communication;
an application program installed in the wireless application device; when the wireless application device receives signals from the code transmitter, the application program in the wireless application device will drive the wireless application device to further transmit the code set wirelessly; and
a server storing all the code sets and a plurality of data corresponding to the code sets; when the server receives the code set from the handset, it will find a data corresponding to the code set and then transfer the data back to the handset wirelessly.

2. The movable broadcasting system by using a code set identification as claimed in claim 1, wherein the application program causes the wireless application device to display the data on the screen thereof.

3. The movable broadcasting system by using a code set identification as claimed in claim 1, wherein the wireless application device is one of a handset, a tablet computer and a wireless device.

4. The movable broadcasting system by using a code set identification as claimed in claim 1, wherein the wireless communication is one of WiFi, Bluetooth, and NFC.

5. The movable broadcasting system by using a code set identification as claimed in claim 1, wherein the code set in the code transmitter is adjustable and a plurality of code sets can be designated to the code transmitter.

6. The movable broadcasting system by using a code set identification as claimed in claim 1, wherein the code set in the code transmitter is adjusted by wireless way or wired way.

7. A movable broadcasting system by using a code set identification, comprising:
a code transmitter installed at a predetermined location; the code transmitter storing at least one code set which can be transferred to at least one wireless application device within an area around the predetermined location by wireless communication;
an application program installed in the wireless application device;
when the wireless application device receives signals from the code transmitter, the application program in the wireless application device will drive the wireless application device to further transmit the code set wirelessly;
a server comprising:
a provider database for storing data inputted by external providers; each data of the provider being directed to a code set; and the code set being stored in the code transmitter;
a customer interface connected to the provider database for interfacing with external customers through a wireless application device; the customer interface receiving the code set and then transfers the code set to the provider database; then a data corresponding to the code set is found in the provider database; then the data corresponding to the code set being transferred back to the wireless application device; and
a code controller connected to the provider database; the code controller serving to manage the code sets between the code transmitter and the provider database.

8. The movable broadcasting system by using a code set identification as claimed in claim 7, further comprising:
a charge unit connected to the customer interface and the provider database for charging to the external providers or customers due to the operation from customers or the providers.

9. The movable broadcasting system by using a code set identification as claimed in claim 7, wherein the application program causes the wireless application device display the data on the screen thereof.

10. The movable broadcasting system by using a code set identification as claimed in claim 7, wherein the wireless application device is one of a handset, a tablet computer and a wireless device.

11. The movable broadcasting system by using a code set identification as claimed in claim 7, wherein the wireless communication is one of WiFi, Bluetooth, and NFC.

12. The movable broadcasting system by using a code set identification as claimed in claim 7, wherein the code set in the code transmitter is adjustable and a plurality of code sets can be designated to the code transmitter.

13. The movable broadcasting system by using a code set identification as claimed in claim 7, wherein the code set in the code transmitter is adjusted by wireless way or wired way.

14. The movable broadcasting system by using a code set identification as claimed in claim 7, wherein each data is set with condition for transmission.
